(19) United States
(12) Patent Application Publication
(10) Pub. No.: US 2026/0000986 A1
(43) Pub. Date: Jan. 1, 2026

(54) NON-TRANSITORY RECORDING MEDIUM RECORDING INFORMATION PROCESSING PROGRAM, INFORMATION PROCESSING METHOD, AND INFORMATION PROCESSING DEVICE

(71) Applicant: KOEI TECMO GAMES CO., LTD., Yokohama-shi (JP)

(72) Inventor: Hidehiko NAKAJIMA, Kanagawa (JP)

(21) Appl. No.: 19/231,558

(22) Filed: Jun. 9, 2025

(30) Foreign Application Priority Data
Jun. 27, 2024 (JP) 2024-104199

(51) Int. Cl. A63F 13/57

(52) U.S. Cl. CPC A63F 13/57

(57) ABSTRACT

A non-transitory computer-readable recording medium storing instructions that are executable by a processor to perform operations, the operations including: causing a first object to acquire first information that the first object recognizes from among information about an environment in a computer game; causing a second object that is different from the first object to assign second information from among the information about the environment to the first object; causing the first object to choose an action of the first object on the basis of the first information and the second information; and causing the first object to execute the chosen action in the computer game.

### CROSS-REFERENCE TO RELATED APPLICATION

This application is based on and claims priority under 35 USC 119 from Japanese Patent Application No. 2024-104199, filed on June 27, 2024, the disclosure of which is incorporated by reference herein.

### BACKGROUND

### TECHNICAL FIELD

The present disclosure relates to a non-transitory recording medium recording an information processing program, an information processing method, and an information processing device.

Japanese Patent No. 7,492,637 discloses an information processing system in which an object existing in a virtual space in a game triggers a cooperative skill, which is an event in the game.

### SUMMARY

An aspect of the present disclosure is a non-transitory computer-readable recording medium storing instructions that are executable by a processor to perform operations, the operations including: causing a first object to acquire first information that the first object recognizes from among information about an environment in a computer game; causing a second object that is different from the first object to assign second information from among the information about the environment to the first object; causing the first object to choose an action of the first object on the basis of the first information and the second information; and causing the first object to execute the chosen action in the computer game.

### BRIEF DESCRIPTION OF DRAWINGS

FIG. 1 is a block diagram showing an example of hardware structures of an information processing device.

FIG. 2 is a diagram for describing a flow of actions of a character.

FIG. 3 is a block diagram showing an example of functional structures of the information processing device.

FIG. 4A is a diagram for describing an example of control by a first control unit and second control unit according to a first exemplary embodiment.

FIG. 4B is a diagram for describing another example of control by the first control unit and second control unit according to the first exemplary embodiment.

FIG. 5 is a flowchart showing an example of information processing.

FIG. 6A is a diagram for describing an example of control by a first control unit and second control unit according to a second exemplary embodiment.

FIG. 6B is a diagram for describing another example of control by the first control unit and second control unit according to the second exemplary embodiment.

FIG. 6C is a diagram for describing still another example of control by the first control unit and second control unit according to the second exemplary embodiment.

FIG. 7 is a diagram for describing an example of control by a first control unit and a second control unit according to a variant example of the second exemplary embodiment.

FIG. 8 is a flowchart showing an example of a flow of processing relating to cooperative actions of a first object and second object according to a third exemplary embodiment.

FIG. 9A is a diagram for describing an example of a flow of operation when a cooperative action is executed.

FIG. 9B is a diagram for describing an example of a flow of operation when a cooperative action is not executed.

FIG. 10 is a flowchart showing another example of a flow of processing relating to cooperative actions of the first object and second object according to the third exemplary embodiment.

FIG. 11A is a diagram for describing an example of a flow of operation when a cooperative action is executed.

FIG. 11B is a diagram for describing an example of a flow of operation when a cooperative action is not achieved.

FIG. 11C is a diagram for describing another example of a flow of operation when a cooperative action is not achieved.

FIG. 12 is a sequence chart showing an example of flows of processing of the first object and second object.

### DESCRIPTION

Below, exemplary embodiments of the present disclosure are described in detail with reference to the attached drawings.

### = First Exemplary Embodiment =

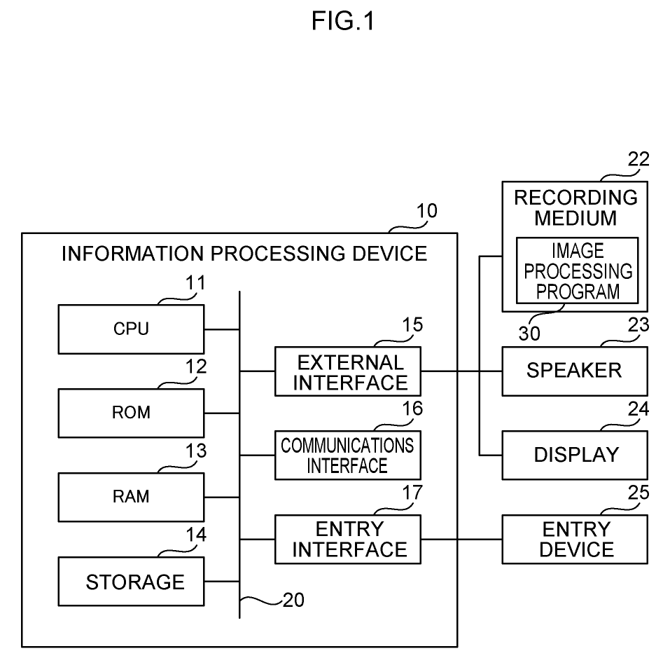

First, hardware structures of an information processing device 10 according to the present exemplary embodiment are described with reference to FIG. 1. The information processing device 10 is, for example, a home video game console, a portable game console, a commercial game console, a smartphone, a tablet terminal, a personal computer or the like. As an example, the present exemplary embodiment describes an example in which a home video game console is employed as the information processing device 10. The information processing device 10 is an example of a "computer".

As shown in FIG. 1, the information processing device 10 is provided with a central processing unit (CPU) 11, read-only memory (ROM) 12, random access memory (RAM) 13, storage 14, an external interface (I/F) 15, a communications interface 16 and an entry interface 17. The CPU 11, ROM 12, RAM 13, storage 14, external interface 15, communications interface 16 and entry interface 17 are respectively connected to be capable of communicating with one another via a bus 20.

The CPU 11 executes various programs and controls respective sections. The CPU 11 is an example of a hardware processor. The ROM 12 is a non-transitory recording medium, is an example of memory, and stores various programs and various kinds of data. The RAM 13 is a non-transitory recording medium, is an example of memory, and serves as a work area, temporarily memorizing programs and data. The storage 14 is a non-transitory recording medium, is an example of memory, is structured by a memory device such as a hard disk drive (HDD), a solid-state drive (SSD), a flash memory or the like, and stores various programs and various kinds of data.

The external interface 15 is an interface for connecting various external devices to the information processing device 10. In the present exemplary embodiment, a recording medium 22, a speaker 23 and a display 24 are connected to the external interface 15.

The recording medium 22 that is employed is a CD-ROM (compact disc read-only memory), a DVD-ROM (digital versatile disc read-only memory), a USB (universal serial bus) memory, an SD memory card or the like. The recording medium 22 stores an image processing program 30 for causing the information processing device 10 to execute a predetermined game. The CPU 11 reads the image processing program 30 from the recording medium 22 via the external interface 15 and executes the image processing program 30, using the RAM 13 as a work area. The image processing program 30 is not limited to modes that are stored at the recording medium 22. The image processing program 30 may be memorized in advance at the storage 14, or may be downloadable to the information processing device 10 via the communications interface 16.

The speaker 23 outputs various sounds. The speaker 23 may be integrated with the information processing device 10, and may be integrated with the display 24. The display 24 is, for example, a liquid crystal display or an organic electroluminescent (EL) display, and displays various kinds of information. The display 24 may integrally include a touch panel. The display 24 may be integrated with the information processing device 10.

The communications interface 16 is an interface for connecting the information processing device 10 to a network. The communications interface 16 employs, for example, a wired communications standard such as Ethernet (registered trademark), FDDI (Fiber Distributed Data Interface) or the like, or a wireless communications standard such as 4G, 5G, 6G, 7G, Wi-Fi (registered trademark) or the like.

The entry interface 17 is an interface for connecting an entry device 25 to the information processing device 10. The entry device 25 is a controller with control buttons and direction keys or the like, a mouse and keyboard, or the like, and is employed for carrying out various kinds of entry. A user uses the entry device 25 to operate the game. Operation information representing details of entry operations that the user carries out using the entry device 25 are stored in the RAM 13. The entry device 25 may be integrated with the information processing device 10. Alternatively, the entry device 25 may be connectable to the information processing device 10. There may be only one of the entry device 25, and there may be a plural number. The entry device 25 may be a touch panel that is integrated with the display 24.

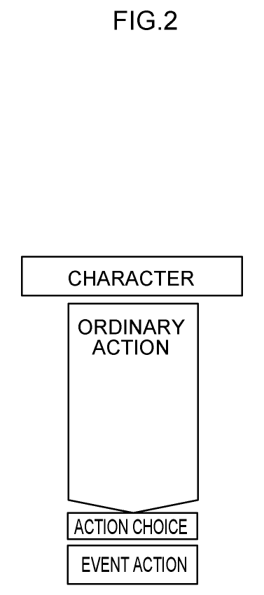

FIG. 2 is a diagram for describing an example of flow of actions of a character in a game delivered by the information processing device 10 according to the present exemplary embodiment. As illustrated in FIG. 2, the information processing device 10 according to the present exemplary embodiment delivers a game in which a character such as a non-player character (NPC), which is a kind of object existing in a virtual space in the game, or the like may perform an action relating to an event in the game (referred to as an "event action"). The meaning of the term "event" as used in the present exemplary embodiment is intended to include various occurrences, mechanisms and the like occurring in the game. The meaning of the term "ordinary action" is intended to include actions other than event actions, and is used in order to distinguish these actions from event actions. Details of ordinary actions are not particularly limited.

Methods for causing a character to perform an event action include methods that continuously monitor an in-game environment. However, when an in-game environment is being continuously monitored, there may be problems with control of plural objects including the character becoming complicated and the like.

Accordingly, in the information processing device 10 according to the present exemplary embodiment, a character chooses actions for itself and executes an event action on the basis of first information recognized by the character and second information assigned from an object different from the character (below referred to as an "other object"). The character itself does not actually perform action choices and the like in the game; an artificial intelligence (AI) or the like controlling the character performs control. However, because the character gives the impression of operating so as to perform action choices and the like itself, where appropriate, the character is described as if the character itself were operating.

An "object" according to the present exemplary embodiment may be, similarly to the character described above, a person appearing in the game such as an NPC or the like, and may be something else. For example, an object may be an animal, a robot, a machine, a tool, an environmental feature such as a swamp, a forest or the like, a fantasy creature and so forth; types of object are not limited. An object may further be a player character operated by a player who is a user of the information processing device 10, and may be a character operated by a player other than the player operating the player character. A character according to the present exemplary embodiment is an example of a first object of the present disclosure, and an other object according to the present exemplary embodiment, which is different from the character, is an example of a second object of the present disclosure.

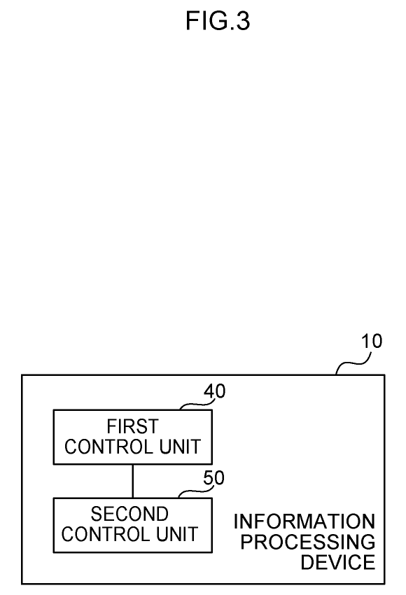

Now, functional structures of the information processing device 10 are described with reference to FIG. 3. As shown in FIG. 3, the information processing device 10 includes a first control unit 40 and a second control unit 50. The CPU 11 functions as the first control unit 40 and the second control unit 50 by executing the image processing program 30.

The first control unit 40 is a control unit that controls a character. The first control unit 40 according to the present exemplary embodiment causes the character to acquire first information that the character recognizes from information about the in-game environment. The information about the in-game environment according to the present exemplary embodiment includes all elements constituting the game, such as fields, backgrounds, objects, parameters and so forth. The information about the in-game environment includes information relating to, for example, a first object and a second object. The information about the in-game environment may also include meta information such as a game mode difficulty level, hardware capabilities and so forth.

The first control unit 40 causes the character to choose an action of the character on the basis of the first information, which is acquired by an information unit 41, and second information, which is described below. The first control unit 40 then causes the character to execute the chosen action.

The second control unit 50 is a control unit that controls the other object. The second control unit 50 according to the present exemplary embodiment causes the other object to assign second information, from the information about the in-game environment, to the character. In the present exemplary embodiment, the second information that is assigned is an information tag corresponding to the second information (referred to as a "second information tag" in the present exemplary embodiment). The meaning of the term "second information" is intended to include information that the other object may provide about an event to which the other object is related. It is sufficient that the second information is information about the event; concrete details are not limited. For example, for an event that is a certain action against an enemy, when the other object sees the enemy, the second information may simply be information relating to that occurrence, such as the statement "an enemy is here", and may be information giving an order to the character, such as "do this action". The first information in this situation is, for example information on what kind of weapon the character is holding, what kind of attacks the character can do and so forth.

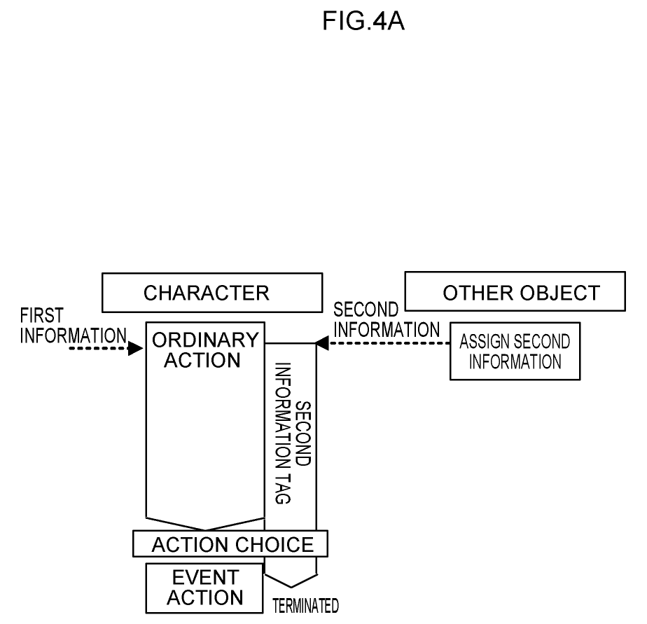

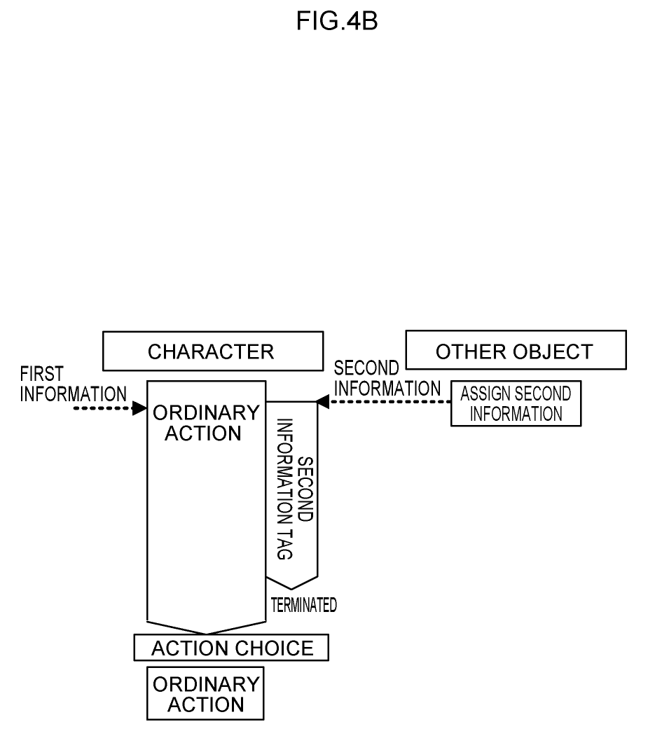

FIG. 4A and FIG. 4B are diagrams for describing examples of control by the first control unit and second control unit according to the present exemplary embodiment. As shown in FIG. 4A, the second control unit 50 causes the other object to assign an information tag corresponding to second information to the character. In the present exemplary embodiment, a valid period is specified for the second information. The second information tag is terminated when the valid period has passed from the second information tag being assigned to the character. The valid period of the second information according to the present exemplary embodiment is equivalent to being "valid until a predetermined condition is satisfied" in the present disclosure.

The first control unit 40 causes the character to acquire the first information. The first control unit 40 monitors for a second information tag being assigned to the character and controls an action of the character. As shown in FIG. 4A, if an ordinary action is being executed when the second information is assigned and the ordinary action cannot be interrupted, then after the ordinary action has been completed, the first control unit 40 causes the character to choose an action of the character on the basis of the first information and the second information corresponding to the second information tag. In the example shown in FIG. 4A, the second information is valid. Accordingly, the character chooses to perform an event action on the basis of the first information and second information. Hence, the first control unit 40 causes the character to execute the event action. When the second information tag is assigned, an event action being performed in response to a previous related event may be continuing. In this case, the event action being performed in response to the previous related event is referred to where appropriate in these descriptions as an ordinary action.

As shown in FIG. 4B, if the valid period of the second information ends and the second information tag is terminated before the ordinary action of the character has been completed, the character chooses to perform another ordinary action. Hence, the first control unit 40 causes the character to execute this ordinary action.

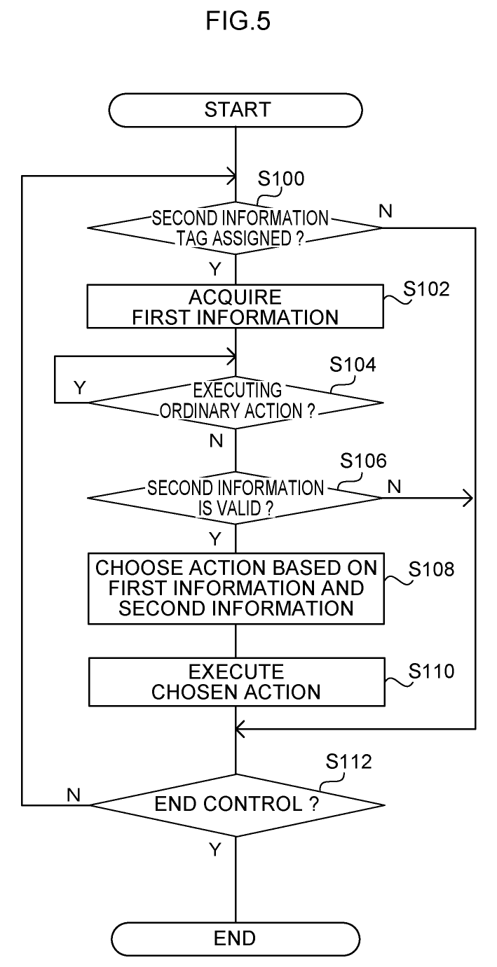

Now, operation of the information processing device 10 is described with reference to FIG. 5. By the CPU 11 executing the image processing program 30, the CPU 11 functions as the first control unit 40 and executes the control processing shown in FIG. 5. The control processing shown in FIG. 5 is processing in which the first control unit 40 controls the character.

As an example, the control processing according to the present exemplary embodiment is executed when the game is started by a player.

In step S100 of FIG. 5, the first control unit 40 makes a determination as to whether a second information tag of second information has been assigned from the other object. When no second information tag has been assigned, the result of the determination in step S100 is negative and the CPU 11 proceeds to step S112. On the other hand, when a second information tag has been assigned, the result of the determination in step S100 is affirmative and the CPU 11 proceeds to step S102.

In step S102, the first control unit 40 acquires the aforementioned first information. A timing for acquiring the first information is not limited in the present exemplary embodiment, provided the acquisition is executed before step S108.

In step S104, the first control unit 40 makes a determination as to whether the character is executing an ordinary action. When the character is executing an ordinary action, the result of the determination in step S104 is affirmative and the first control unit 40 goes into a waiting state. On the other hand, when the character is not executing an ordinary action, that is, when an ordinary action that was being executed has been completed or the character is not doing any action, the result of the determination in step S104 is negative and the CPU 11 proceeds to step S106.

In step S106, the first control unit 40 makes a determination as to whether the assigned second information is valid. For example, in the mode described in reference to the above-described FIG. 4A and FIG. 4B, the first control unit 40 makes a determination as to whether the second information tag is in the valid period. When the second information is not valid, the result of the determination in step S106 is negative and the CPU 11 proceeds to step S112.

On the other hand, when the second information is valid, the result of the determination in step S106 is affirmative and the CPU 11 proceeds to step S108. In step S108, the first control unit 40 causes the character to choose an action of the character on the basis of the first information and the second information.

In step S110, the first control unit 40 executes the action chosen by the character in step S108. In the situation illustrated in FIG. 4A, in step S108 the character chooses to execute an event action, and in step S110 the character executes the chosen event action. Alternatively, in the situation illustrated in FIG. 4B, in step S108 the character chooses to execute an ordinary action on the basis of the first information and second information (the second information tag). More specifically, because the first control unit 40 has terminated the second information tag, the character chooses to execute an ordinary action on the basis of the details of the first information and the fact that the second information tag is out of the valid period. In step S110, the character executes the chosen ordinary action.

In step S112, the first control unit 40 makes a determination as to whether to end the control processing shown in FIG. 5. For example, in the present exemplary embodiment, the control processing shown in FIG. 5 ends when a predetermined end condition is satisfied, such as the player ending the game or the like. Accordingly, until the predetermined end condition is satisfied, results of the determination in step S112 are negative and the first control unit 40 repeatedly returns to step S100 and executes the processing of steps S100 to S110.

On other hand, when the predetermined end condition is satisfied, the result of the determination in step S112 is affirmative and the control processing shown in FIG. 5 ends.

### = Second Exemplary Embodiment =

In the first exemplary embodiment, the other object only carries out the action of assigning second information (a second information tag) about an event to the character. In the present exemplary embodiment, by contrast, a mode is described in which the other object performs an event action relating to the event. Examples of this include an event in which the character and the other object cooperate to succeed in the event, and so forth.

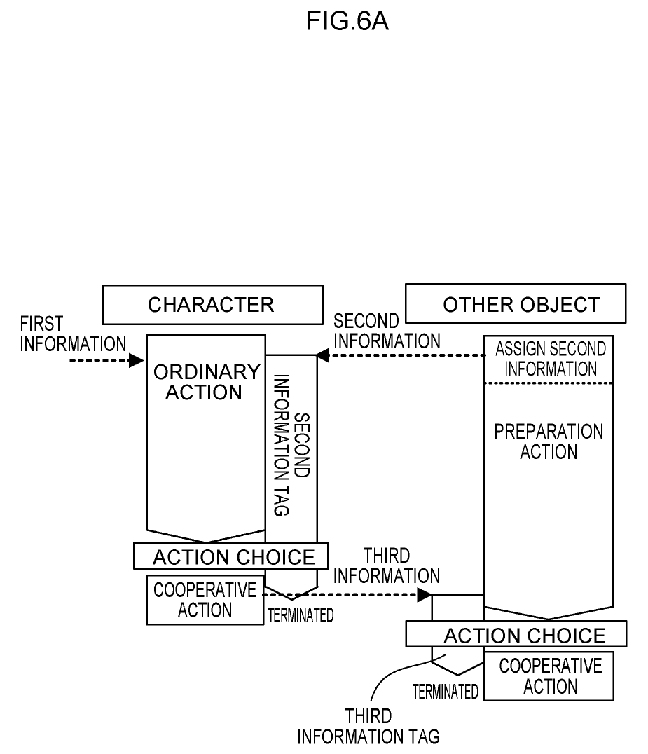

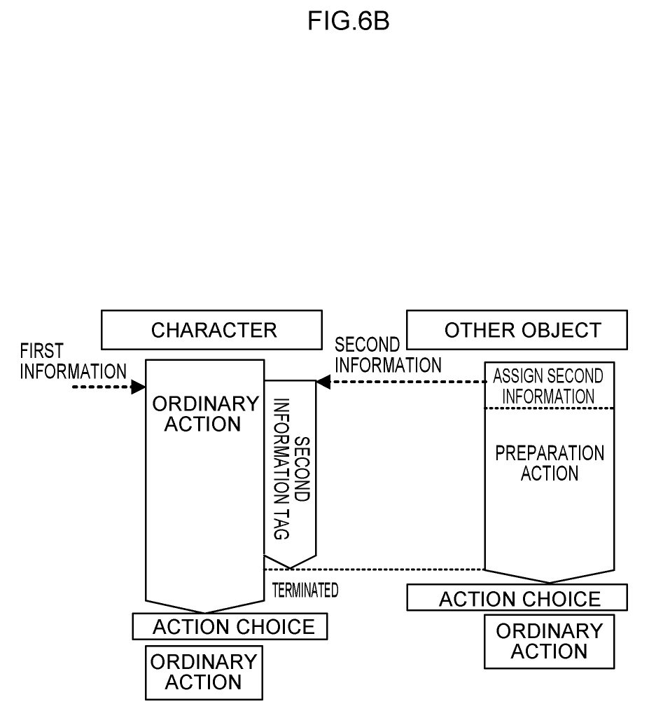

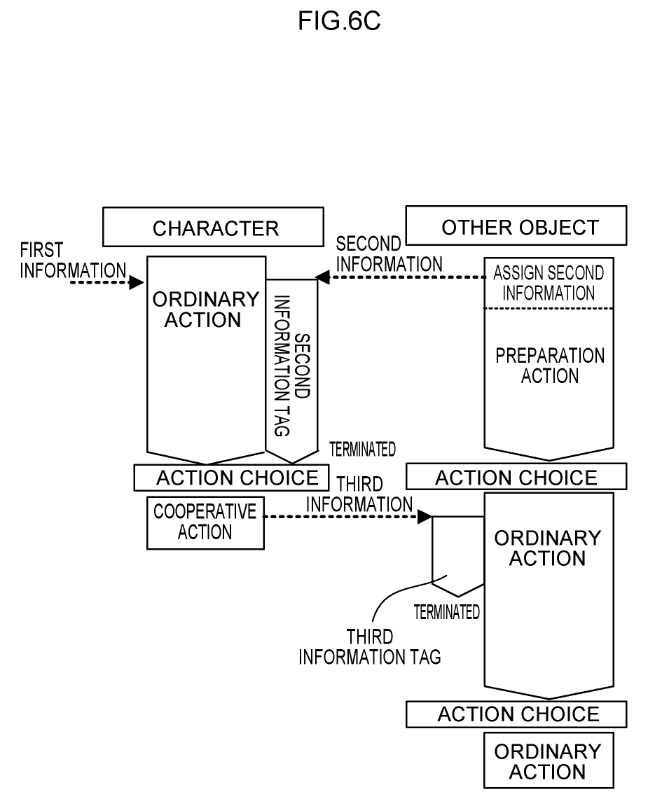

Structures of the information processing device 10 are the same as in the first exemplary embodiment, and accordingly are not described here. In the present exemplary embodiment, details of control of the character by the first control unit 40 differ from details of control of the other object by the second control unit 50. Accordingly, these controls are described with reference to FIG. 6A to FIG. 6C. FIG. 6A to FIG. 6C are diagrams for describing examples of control by the first control unit and second control unit according to the present exemplary embodiment. The examples shown in FIG. 6A to FIG. 6C depict a case in which the character and the other object perform cooperative actions as an event action. The cooperative actions according to the present exemplary embodiment are examples of a "predetermined action" and a "corresponding action" of the present disclosure.

As shown in FIG. 6A, the second control unit 50 causes the other object to assign an information tag corresponding to second information about a cooperative action to the character. In the present exemplary embodiment, a valid period is specified for the second information. The second information tag is terminated when the valid period has passed from the second information tag being assigned to the character. The second control unit 50 also causes the other object to execute the cooperative action or preparation for the cooperative action, or the like.

Meanwhile, the first control unit 40 causes the character to acquire the first information. The first control unit 40 monitors for a second information tag being assigned to the character and controls an action of the character. As shown in FIG. 6A, if the character is executing an ordinary action when the second information is assigned and the ordinary action cannot be interrupted, then after the ordinary action has been completed, the first control unit 40 causes the character to choose an action of the character on the basis of the first information and the second information corresponding to the second information tag. In the example shown in FIG. 6A, the second information is valid. Accordingly, the character chooses to perform a cooperative action on the basis of the first information and second information. Hence, the first control unit 40 causes the character to execute the cooperative action. In addition, the first control unit 40 causes the character to assign third information relating to the cooperative action of the character to the other object. In the present exemplary embodiment, an information tag corresponding to the third information (referred to as a "third information tag" in the present exemplary embodiment) is assigned as the third information. Similarly to the second information, a valid period is specified for the third information according to the present exemplary embodiment.

The second control unit 50 monitors for the third information tag being assigned to the other object. When the aforementioned preparation action is completed, the second control unit 50 causes the other object to choose an action of the other object on the basis of the third information. In the example shown in FIG. 6A, the third information is valid. Accordingly, the other object chooses to perform a cooperative action on the basis of the third information. Hence, the second control unit 50 causes the other object to execute the cooperative action.

Thus, it is sufficient that the first control unit 40 monitors for an information tag (the second information tag) being assigned to the character and that the second control unit 50 monitors for an information tag (the third information tag) being assigned to the other object; cooperative actions may be achieved without monitoring of cooperation partners being necessary.

FIG. 6B shows a situation in which the valid period of the second information tag is a period that the other object requires for a preparation action for a cooperative action. That is, the second information tag that is assigned to the character is terminated according to a timing at which the other object completes the preparation action. If the character has not completed an ordinary action before the other object completes the preparation action, the character chooses to perform another ordinary action.

Thus, even when the cooperative actions are not achieved, it is sufficient that the first control unit 40 monitors for an information tag (the second information tag) being assigned to the character; dedicated processing for a failure of cooperation is not necessary.

FIG. 6C shows a situation in which, although the character performs a cooperative action, the other object does not perform a cooperative action due to, for example, a discrepancy causing the other object to complete a preparation action early; that is, a situation in which the cooperative actions are not achieved.

Similarly to the example shown in FIG. 6A, the character performs a cooperative action and the first control unit 40 causes the character to assign the third information relating to the cooperative action of the character to the other object. In the example shown in FIG. 6C, the other object has already completed the preparation action before the third information tag is assigned to the other object. Accordingly, the other object chooses to perform an ordinary action, and performs the chosen ordinary action. During the execution of this ordinary action, the third information tag is assigned to the other object from the character. The valid period of this third information tag is shorter than the valid period of the second information tag. Because the valid period of the third information tag is short, as shown in FIG. 6C, the third information tag is terminated before the other object completes the ordinary action that is being executed when the third information tag is assigned, before the next action choice is made. As a result, the other object chooses to perform another ordinary action at the time of this action choice.

Thus, even in an irregular case in which cooperative actions are not achieved due to a discrepancy or the like, it is sufficient that the first control unit 40 monitors for an information tag (the second information tag) being assigned to the character and the second control unit 50 monitors for an information tag (the third information tag) being assigned to the other object; dedicated processing for a failure of cooperation is not necessary.

### - Variant example -

In the above descriptions of the present exemplary embodiment, a mode is described in which the character and the other object perform cooperative actions synchronously. In the present variant example, a mode is described in which cooperative actions are performed asynchronously. The meaning of the term "asynchronous cooperative actions" includes, for example, the other object preparing an item and the character using the item and/or the other object preparing for an event and the character performs the event. Specific examples can include cooperative actions in which the other object spreads oil in a certain area and the character enters the area and sets fire to the oil.

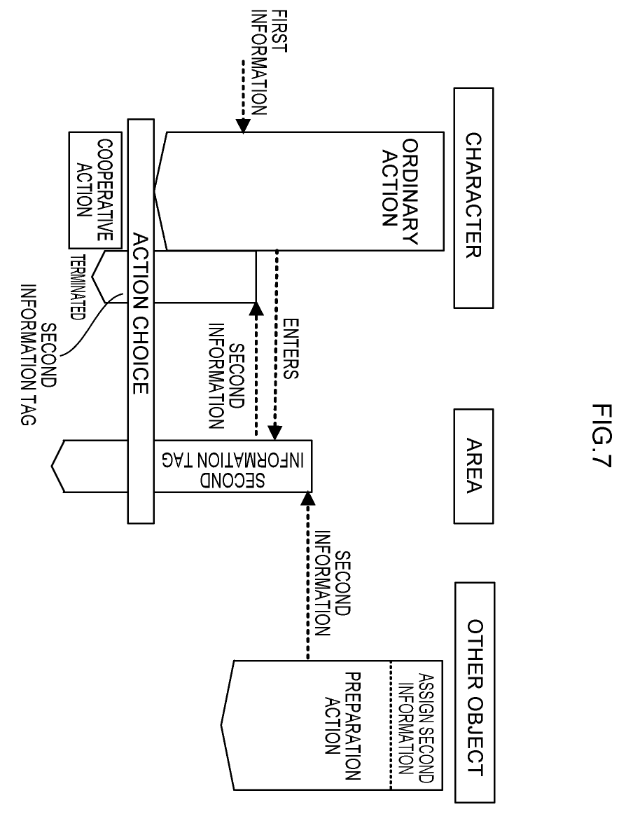

FIG. 7 is a diagram for describing an example of control by the first control unit and second control unit according to the present variant example. As shown in FIG. 7, the other object assigns an information tag of the second information to a certain area. That is, the second control unit 50 creates an area to which the information tag is assigned. In the specific example described above, the other object assigns a second information tag stating "spread with oil" to the area in which the oil is spread. When an object enters the area, this information tag assigned to the area is assigned to the object entering the area, and when the object leaves the area, the assigned information tag is terminated.

In the example shown in FIG. 7, the character enters the area to which the second information tag has been assigned, and the second information tag is assigned to the character. If the character is still located in the area when the character completes an ordinary action, the first control unit 40 chooses to perform a cooperative action on the basis of the first information and second information. In the specific example described above, on the basis of first information stating "carrying a fire-starting tool" and the second information stating "spread with oil", the character chooses to perform the cooperative action "start fire". Then the first control unit 40 causes the character to perform the "start fire" cooperative action.

Thus, even for asynchronous cooperative actions as in the present variant example, similarly to the other modes described above, it is sufficient to monitor for information tags being assigned to objects, and cooperative actions may be achieved.

Furthermore, when the character performs the cooperative action, the third information tag is assigned from the character to the other object as illustrated in FIG. 6A. Therefore, provided the other object is monitoring for an information tag (the third information tag) being assigned to the other object, a determination may be made as to whether the prepared item has been used.

### = Third Exemplary Embodiment =

Now, a third exemplary embodiment is described. In the present exemplary embodiment, a mode is described in which a first object and a second object perform cooperative actions. In the present exemplary embodiment, the term "tight cooperative action" is intended to include the first object and the second object performing predetermined actions at the same time. The term "broad cooperative action" is intended to include one of the objects transmitting information (assigning an information tag) and the other of the objects performing an action on the basis of the transmitted information.

Structures of the information processing device 10 according to the present exemplary embodiment are the same as in the first and second exemplary embodiments, and accordingly are not described in detail here.

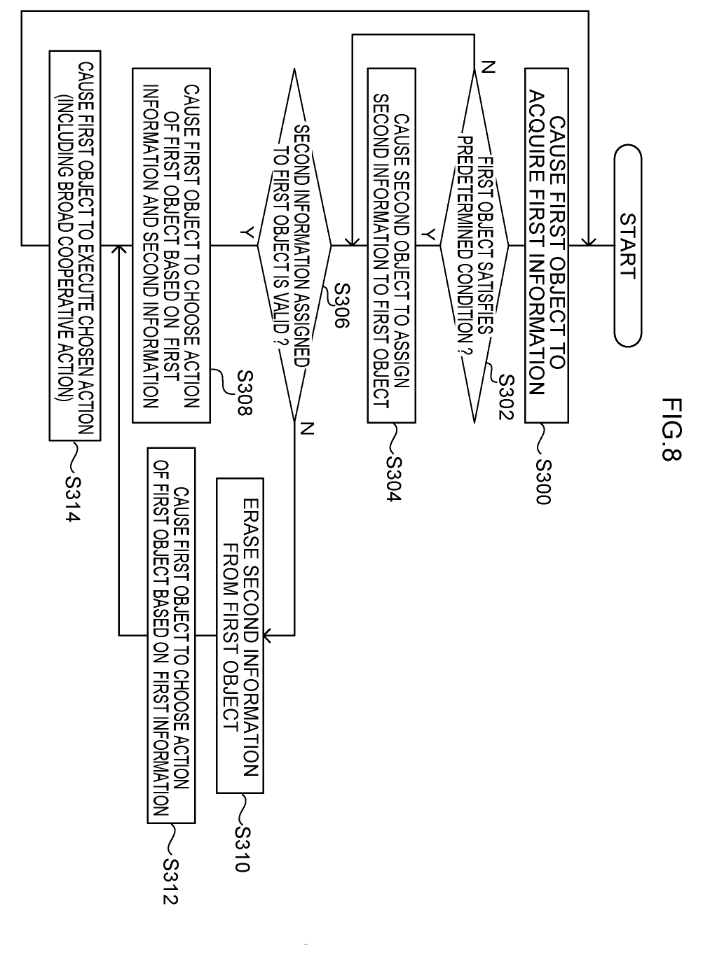

FIG. 8 shows an example of a flow of processing relating to cooperative actions of the first object and second object. The processing shown in FIG. 8 is processing in which only the first control unit 40 monitors for information being assigned to an object that is a control target. In this case, as an example, the first control unit 40 is a character AI for the first object.

In step S300 of FIG. 8, the first control unit 40 causes the first object to acquire first information. The first information in this case includes information on an action currently being executed by the first object. For example, the first information includes the possibility of canceling the action currently being executed by the first object.

In step S302, the second control unit 50 makes a determination as to whether the first object satisfies a predetermined condition. For example, the predetermined condition may be the first object being within a predetermined range of the second object, the first object and the second object having a predetermined relationship such as mutual antagonism, mutual friendship or the like, or selection of the first object by the second object or a player.

When the predetermined condition is satisfied, the result of the determination in step S302 is affirmative and the CPU 11 proceeds to step S304. In step S304, the second control unit 50 causes the second object to assign the second information to the first object. After the processing of step S304, the CPU 11 proceeds to step S306.

On the other hand, when the predetermined condition is not satisfied, the result of the determination in step S302 is negative and the CPU 11 proceeds to step S306. In step S306, the first control unit 40 makes a determination as to whether the second information assigned to the first object is valid. When the second information assigned to the first object is valid, the result of the determination in step S306 is affirmative and the CPU 11 proceeds to step S308. In step S308, the first control unit 40 causes the first object to choose an action of the first object on the basis of the first information and second information. After the processing of step S308, the CPU 11 proceeds to step S314. The first information mentioned above includes information on the action currently being executed by the first object. Accordingly, for example, when the first information indicates that canceling the action being executed by the first object (an ordinary action) is disabled, the action of the first object chosen by the first control unit 40 is to "continue the current action" (sustain the ordinary action). The processing shown in FIG. 8 is a processing loop including periodic execution at intervals of a number of frames. Thus, after the ordinary action is completed, a broad cooperative action is executed.

On the other hand, when the second information assigned to the first object is not valid, that is, when the second information is invalid, the result of the determination in step S306 is negative and the CPU 11 proceeds to step S310. When no second information is assigned to the first object, this is treated as the second information being invalid.

In step S310, because the second information is invalid, the first control unit 40 erases the second information from the first object. Then, in step S312, the first control unit 40 causes the first object to choose an action of the first object on the basis of the first information, after which the CPU 11 proceeds to step S314.

In step S314, the first control unit 40 causes the first object to execute the chosen action (which may be a broad cooperative action). When the processing of step S314 is completed, the CPU 11 returns to step S310 and the processing described above is repeated.

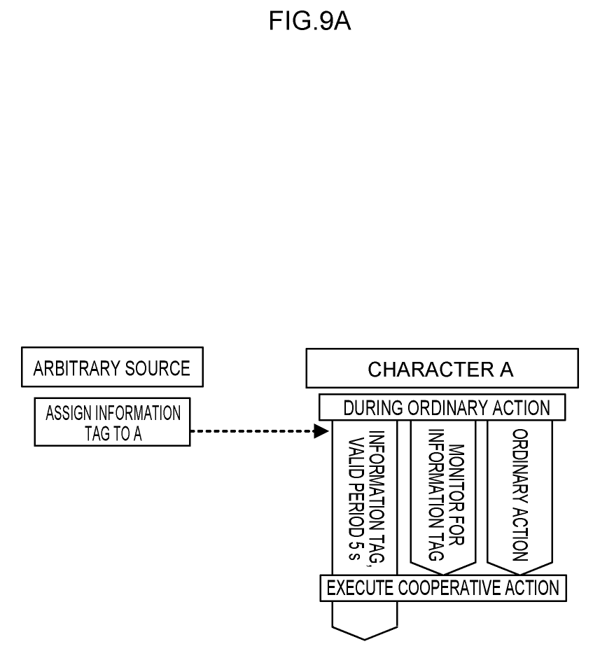

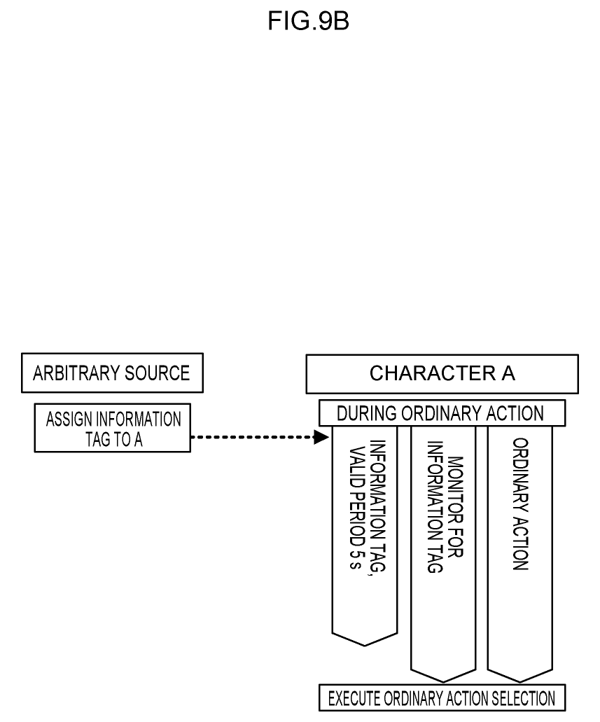

Specific examples of operation of the first object and second object by the processing that is described above with reference to FIG. 8 are described with reference to FIG. 9A and FIG. 9B. FIG. 9A and FIG. 9B show examples of operation in which the first object is "character A", the first control unit 40 executes monitoring of character A for an information tag, and the second object is an "arbitrary source". The monitoring referred to here is intended to include acquiring information, determining whether or not the information is valid, choosing actions on the basis of the acquired information, and the like. For example, the monitoring corresponds to step S300, step S306, step S308, step S312 and such in FIG. 8.

FIG. 9A shows an example of flow of an operation in which character A executes a cooperative action. When character A satisfies a predetermined condition (the result of the determination in step S302 of FIG. 8 is affirmative), the arbitrary source is caused by the second control unit 50 to assign an information tag corresponding to second information to character A (step S304 in FIG. 8), with a valid period from the assignment of 5 seconds.

Character A, to which the information tag is assigned during an ordinary action, performs monitoring for an information tag assigned by the first control unit 40. When character A completes the ordinary action, character A determines that the information tag assigned by the first control unit 40 is valid (the result of the determination in step S306 of FIG. 8 is affirmative). Accordingly, character A chooses to execute a cooperative action (a broad cooperative action) on the basis of the first information acquired by character A and the second information according to the assigned information tag (step S308 in FIG. 8). Hence, character A executes the cooperative action (step S314 in FIG. 8).

Thus, in the example shown in FIG. 9A, execution of a cooperative action is enabled simply by character A monitoring for an information tag being assigned to character A.

On the other hand, FIG. 9B shows an example of a flow of operation in which character A does not execute the cooperative action. When character A satisfies the predetermined condition (the result of the determination in step S302 of FIG. 8 is affirmative), the arbitrary source is caused by the second control unit 50 to assign an information tag corresponding to second information to character A, with a valid period from the assignment of 5 seconds.

Character A, to which the information tag is assigned during an ordinary action, performs monitoring for an information tag assigned by the first control unit 40. In the example shown in FIG. 9B, character A completes the ordinary action after 5 seconds have passed from the information tag being assigned. When the information tag reaches the valid period of 5 seconds, the information tag becomes invalid (the result of the determination in step S306 of FIG. 8 is negative), and therefore the information tag is erased from character A (step S310 in FIG. 8). Accordingly, when character A completes the ordinary action, character A chooses to execute an ordinary action selection (step S312 in FIG. 8) on the basis of the first information acquired by character A. Hence, character A performs another ordinary action (step S314 in FIG. 8).

Thus, in the example shown in FIG. 9B, even though character A simply monitors for an information tag being assigned to character A, a cooperative action is not executed when the second information is invalid. Therefore, execution of, for example, a cooperative action that is no longer applicable to the situation of the moment may be prevented.

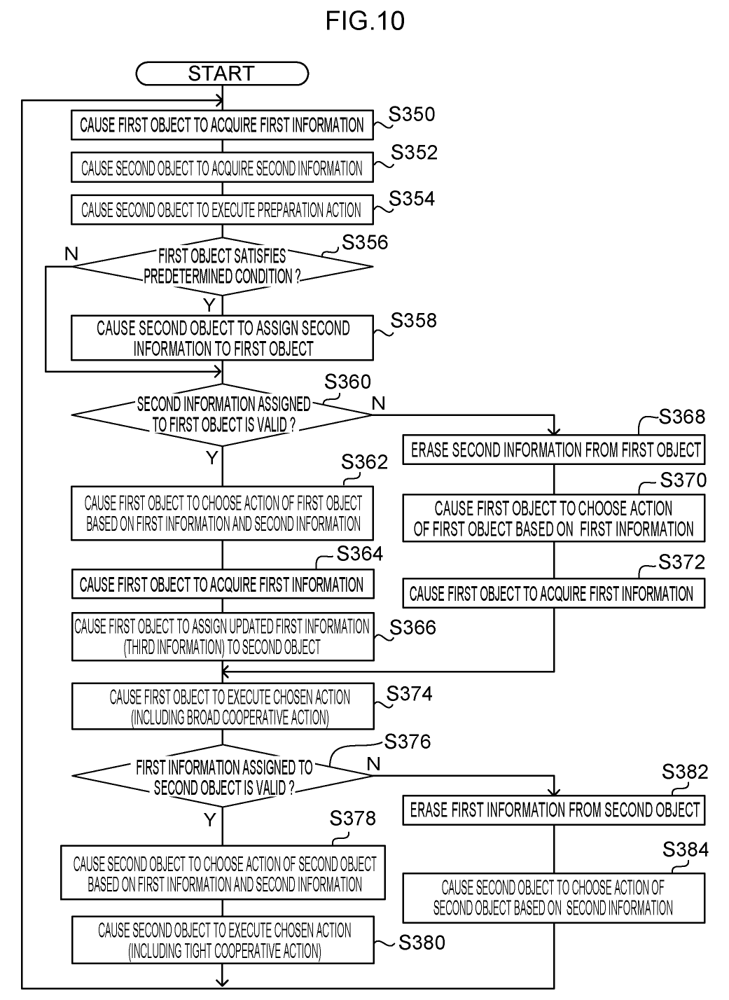

FIG. 10 shows another example of a flow of processing relating to cooperative actions of a first object and second object. The processing shown in FIG. 10 is processing in which the first control unit 40 and the second control unit 50 perform respective monitoring for information being assigned to the objects that are the control targets. Here, as an example, the first control unit 40 is a character AI for the first object and the second control unit 50 is a character AI for the second object.

In step S350 of FIG. 10, the first control unit 40 causes the first object to acquire the first information. In the present processing, the first information includes information on an action currently being executed by the first object. For example, the first information includes the possibility of canceling the action currently being executed by the first object.

Then, in step S352, the second control unit 50 causes the second object to acquire the second information. In the present processing, the second information includes information that the second object recognizes among information about the in-game environment. The second information includes information on an action currently being executed by the second object. For example, the second information includes the possibility of canceling the action currently being executed by the second object.

In step S354, the second control unit 50 causes the second object to execute a preparation action. The meaning of the term "preparation action" as used herein is intended to include, for example, an action that may be canceled. The preparation action may be executed on the basis of an instruction from the player and may be executed on the basis of control by the character AI.

In step S356, similarly to the processing described above, the second control unit 50 makes a determination as to whether the first object satisfies a predetermined condition.

When the predetermined condition is satisfied, the result of the determination in step S356 is affirmative and the CPU 11 proceeds to step S358. In step S358, the second control unit 50 causes the second object to assign second information to the first object. After the processing of step S358, the CPU 11 proceeds to step S360.

On the other hand, when the predetermined condition is not satisfied, the result of the determination in step S356 is negative and the CPU 11 proceeds to step S360. In step S360, the first control unit 40 makes a determination as to whether the second information assigned to the first object is valid. When the second information assigned to the first object is valid, the result of the determination in step S360 is affirmative and the CPU 11 proceeds to step S362. In step S362, the first control unit 40 causes the first object to choose an action of the first object on the basis of the first information and the second information.

In step S364, the first control unit 40 causes the first object to acquire the first information. In step S366, the first control unit 40 causes the first object to assign the updated first information (in other words, third information) to the second object. This first information may include information relating to a cooperative action of the first object. Therefore, the first information may be information that includes the third information according to the second exemplary embodiment described above.

On the other hand, when the second information assigned to the first object is not valid, that is, when the second information is invalid, the result of the determination in step S360 is negative and the CPU 11 proceeds to step S368. In this processing too, when no second information is assigned to the first object, this is treated as the second information being invalid.

In step S368, because the second information is invalid, the first control unit 40 erases the second information from the first object. Thus, the first object is put into a state in which no second information is assigned. Then, in step S370, the first control unit 40 causes the first object to choose an action of the first object on the basis of the first information. In step S372, the first control unit 40 causes the first object to acquire the first information, after which the CPU 11 proceeds to step S374.

In step S374, the first control unit 40 executes the action chosen by the first object (which may be a broad cooperative action).

Then, in step S376, the second control unit 50 makes a determination as to whether the first information assigned to the second object is valid. When the first information assigned to the second object is valid, the result of the determination in step S376 is affirmative and the CPU 11 proceeds to step S378. In step S378, the second control unit 50 causes the second object to choose an action of the second object on the basis of the first information and the second information. The second control unit 50 may cause the second object to determine the action of the second object on the basis of only the first information, which is to say, only the third information.

Then, in step S380, the second control unit 50 causes the second object to execute the chosen action (which may be a tight cooperative action). When the processing of step S380 is complete, the CPU 11 returns to step S350 and the processing described above is repeated.

On the other hand, when the first information assigned to the second object is not valid, that is, when the first information is invalid, the result of the determination in step S376 is negative and the CPU 11 proceeds to step S382.

In step S382, because the first information is invalid, the second control unit 50 erases the first information from the second object. Thus, the second object is put into a state in which no first information is assigned. Then, in step S384, the second control unit 50 causes the second object to choose an action of the second object on the basis of the second information. The action chosen here may be a preparation action. When the processing of step S384 is complete, the CPU 11 returns to step S350 and the processing described above is repeated.

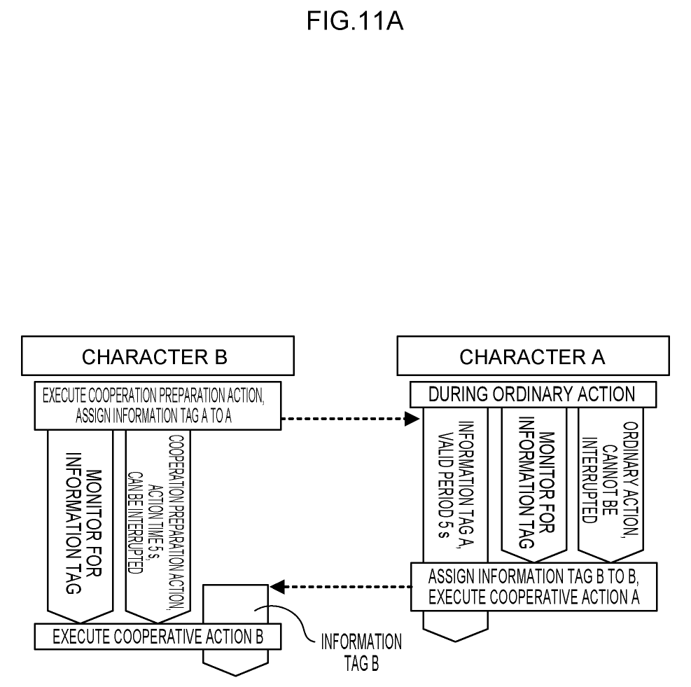

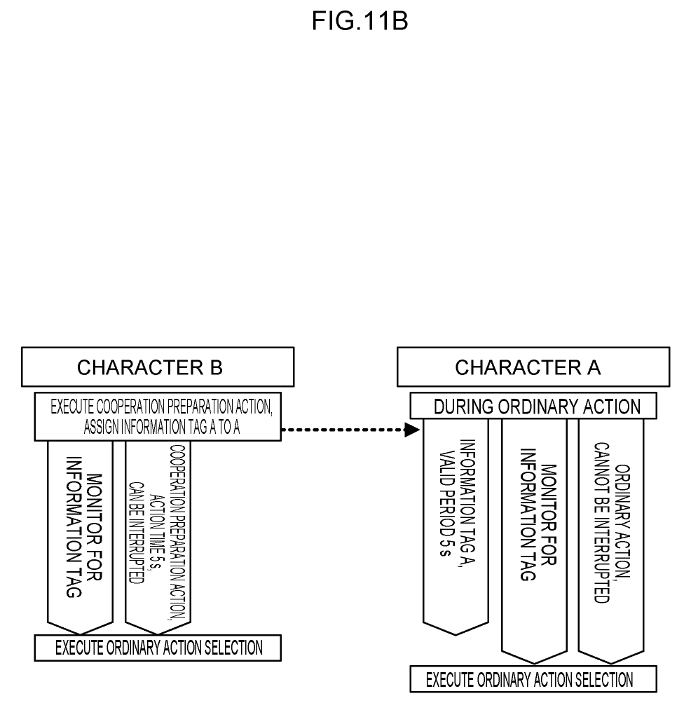

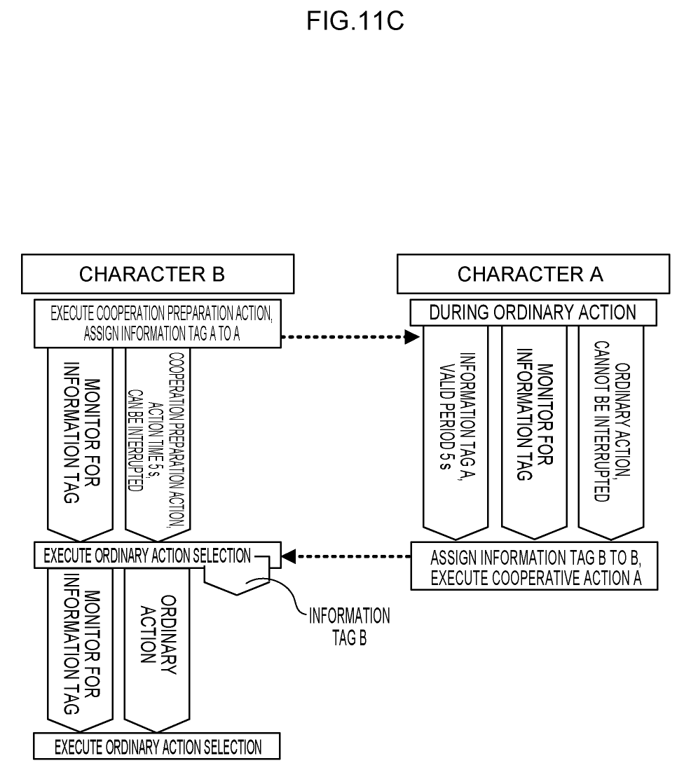

Specific examples of operation of the first object and second object by the processing that is described above with reference to FIG. 10 are described with reference to FIG. 11A to FIG. 11C.

FIG. 11A to FIG. 11C show examples of operation in which the first object is "character A", the first control unit 40 executes monitoring of character A for an information tag, the second object is "character B", and the second control unit 50 executes monitoring of character B for an information tag.

FIG. 11A shows an example of flow of an operation in which character A and character B execute cooperative actions. Character B executes a cooperation preparation action, which may be interrupted, with a time required for the action (an action period) of 5 seconds (step S352 in FIG. 10). When character A satisfies a predetermined condition (the result of the determination in step S356 of FIG. 10 is affirmative), character B is caused by the second control unit 50 to assign an information tag A corresponding to second information to character A (step S358 in FIG. 10), with a valid period from the assignment of 5 seconds. Character B continues the cooperation preparation action while performing monitoring for an information tag.

Character A, to which information tag A is assigned during an ordinary action, performs monitoring for information tag A being assigned by the first control unit 40. When character A completes the ordinary action, character A is caused by the first control unit 40 to determine that the assigned information tag A is valid (the result of the determination in step S360 of FIG. 10 is affirmative). Accordingly, character A chooses to execute a cooperative action A on the basis of the first information acquired by character A and the second information corresponding to the assigned information tag A (step S362 in FIG. 10).

In addition, character A is caused by the first control unit 40 to assign an information tag B corresponding to the first information (the third information) to character B (step S366 in FIG. 10). Character A then executes cooperative action A (step S374 in FIG. 10).

After completing the cooperation preparation action, character B, to which information tag B is assigned, is caused by the second control unit 50 to determine that the assigned information tag B is valid (the result of the determination in step S376 of FIG. 10 is affirmative). Accordingly, character B chooses to execute a cooperative action (a tight cooperative action) on the basis of the second information acquired by character B and the first information (third information) corresponding to the assigned information tag B (step S378 in FIG. 10). Hence, character B executes the cooperative action (step S380 in FIG. 10).

Thus, in the example shown in FIG. 11A, execution of cooperative actions is enabled simply by character A and character B monitoring for an information tag being assigned to each character. That is, the cooperative actions may be executed without the characters needing to monitor one another.

Alternatively, FIG. 11B shows an example of a flow of operation in which neither of character A and character B executes a cooperative action and the cooperative actions are not achieved. Character B executes a cooperation preparation action, which may be interrupted, with a time required for the action (the action period) of 5 seconds (step S352 in FIG. 10). When character A satisfies the predetermined condition (the result of the determination in step S356 of FIG. 10 is affirmative), character B is caused by the second control unit 50 to assign the information tag A corresponding to the second information to character A (step S358 in FIG. 10), with a valid period from the assignment of 5 seconds, which is the same as the time required for the cooperation preparation action. Character B continues the cooperation preparation action while performing monitoring for an information tag.

Character A, to which information tag A is assigned during an ordinary action, performs monitoring for information tag A being assigned by the first control unit 40. If time passed from the assignment of the information tag A reaches the valid period of 5 seconds, character A is caused by the first control unit 40 to determine that the assigned information tag A is invalid (the result of the determination in step S360 of FIG. 10 is negative) and information tag A is erased (step S368 in FIG. 10).

As a result, character B completes the cooperation preparation action in a state in which the information tag B corresponding to the first information (third information) has not been assigned from character A. The second control unit 50 determines that information tag B is invalid (the result of the determination in step S376 of FIG. 10 is negative), and character B chooses to execute an ordinary action selection on the basis of the second information acquired by character B (step S384 in FIG. 10).

Meanwhile, because character A completes the ordinary action after information tag A has been erased, the first control unit 40 determines that information tag A is invalid (the result of the determination in step S360 of FIG. 10 is negative). Accordingly, character A chooses to execute an ordinary action selection on the basis of the first information acquired by character A (step S370 in FIG. 10). Hence, character A performs another ordinary action (step S374 in FIG. 10).

Thus, in the example shown in FIG. 11B, simply by character A and character B each monitoring for an information tag being assigned to the character, character A does not execute the cooperative action if an ordinary action by character A is not completed while character B is performing the cooperation preparation action. That is, execution of cooperative actions may be prevented without dedicated processing being provided for both character A and character B.

FIG. 11C shows an example of a flow of operation in which character A performs a cooperative action but character B does not perform a cooperative action for some reason, and the cooperative actions are not achieved. Similarly to the example shown in FIG. 11B, character B executes a cooperation preparation action and assigns the information tag A corresponding to the second information to character A. Character B continues the cooperation preparation action while performing monitoring for an information tag.

Character A, to which information tag A is assigned during an ordinary action, performs monitoring for information tag A being assigned by the first control unit 40. Character A completes the ordinary action before information tag A is erased. Therefore, when the ordinary action is completed, the first control unit 40 determines that information tag A is valid (the result of the determination in step S360 of FIG. 10 is affirmative). Accordingly, character A chooses to execute cooperative action A on the basis of the first information acquired by character A and the second information corresponding to the assigned information tag A (step S362 in FIG. 10). In addition, character A is caused by the first control unit 40 to assign the information tag B corresponding to the first information (the third information) to character B (step S366 in FIG. 10). Character A then executes cooperative action A (step S374 in FIG. 10).

Meanwhile, due to a discrepancy, character B completes the cooperation preparation action before information tag B is assigned. Therefore, the second control unit 50 determines that information tag B is invalid (the result of the determination in step S376 of FIG. 10 is negative), and character B chooses to execute an ordinary action selection on the basis of the second information acquired by character B (step S384 in FIG. 10). Therefore, even though information tag B is assigned, character B is executing the ordinary action and monitoring for information tag B is being performed by the second control unit 50.

The valid period of the information tag B corresponding to the first information (third information) is relatively short, being shorter than, for example, the time character B requires for the cooperation preparation action (5 seconds in FIG. 11C). Therefore, before character B completes the ordinary action, the second control unit 50 determines that information tag B is invalid (the result of the determination in step S376 of FIG. 10 is negative) and information tag B is erased (step S382 in FIG. 10). Subsequently, character B completes the ordinary action. The second control unit 50 again determines that information tag B is invalid (the result of the determination in step S376 of FIG. 10 is negative). Accordingly, character B again chooses to execute an ordinary action selection on the basis of the second information acquired by character B (step S384 in FIG. 10).

Thus, in the example shown in FIG. 11C, even in an irregular situation in which character B does not perform a cooperative action for some reason, such as character B having already completed the cooperation preparation action due to a discrepancy or the like, and the cooperative actions are not achieved, execution of a cooperative action may be prevented without dedicated processing being provided for both character A and character B.

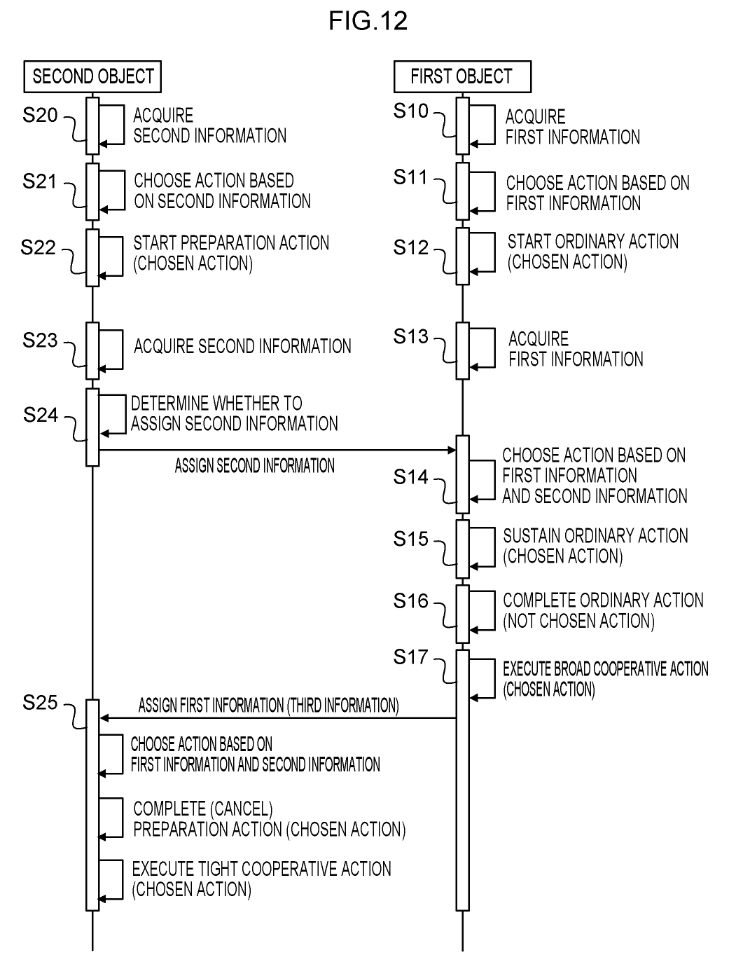

Now, flows of processing for the first object and second object according to the present exemplary embodiment as described above are described with reference to FIG. 12 in a time sequence for each object. FIG. 12 is a sequence chart showing an example of the flows of processing of the first object and the second object. In order to avoid over-complex recitations, recitations in FIG. 12 are given with the first object and second object acting as respective subjects as appropriate. For example, the recitation "the first object acquires the first information" is equivalent to "the CPU 11 causes the first object to acquire the first information". An embodiment is applicable in which the first object and the second object are, for example, characters equipped with character AIs and the character AIs choose actions of the characters.

As shown in FIG. 12, in step S10, the first object acquires first information. In step S11, the first object chooses an action on the basis of the acquired first information. In step S12, the first object starts the chosen action, which is an ordinary action in this case. In step S13, the first object acquires the first information again. Subsequently, the second information is assigned by the second object and, in step S14, the first object chooses an action on the basis of the first information and the second information. In step S15, the first object sustains the chosen action, which is the ordinary action in this case. In step S16, the first object completes the ordinary action. In step S17, the first object executes the chosen action, which is a broad cooperative action in this case. In association with the execution of the cooperative action, the first object assigns the first information (the third information) to the second object.

Meanwhile, as shown in FIG. 12, in step S20 the second object acquires second information. In step S21, the second object chooses an action on the basis of the acquired second information. In step S22, the second object starts the chosen action, which is a cooperation preparation action in this case. In step S23, the second object acquires the second information. In step S24, the second object makes a determination as to whether or not to assign the second information to the first object. When the second object makes the decision to assign, the second object assigns the second information to the first object. Subsequently, the first information (the third information) is assigned by the first object and, in step S25, the second object chooses an action on the basis of the first information (the third information) and the second information. Then, after completing (canceling) the cooperation preparation action that was the chosen action, the second object executes the chosen action, which is a tight cooperative action.

As described above, the information processing device 10 according to the modes described above causes the first object to acquire first information that the first object recognizes among information about the environment in the game, causes the second object, which is different from the first object, to assign second information among the information about the environment to the first object, and causes the first object to choose an action of the first object on the basis of the first information and the second information. According to the information processing device 10 of the present exemplary embodiments with this configuration, the first object may acquire information to be used in choosing actions without continuously monitoring the in-game environment. Further, according to the information processing device 10 of the present exemplary embodiments, because it is sufficient that the first object monitors information of the first object itself, processing may be simplified.

The technology of the present disclosure is not limited to the modes described above and may be applied to all AI control in a game. For example, the technology may be applied to a situation in which, because a character is continuously attacking an enemy, the character issues a standby command to an allied party NPC such that the NPC will not impede the character. In this situation, the character, which is the second object, assigns a second information tag stating "continuously attacking" or "standby command" to the allied party NPC. The allied party NPC, which is the first object, chooses an action in order to not impede the character on the basis of this second information and the first information that is information about the surroundings of the NPC and such. Other examples include a situation in which, because an enemy is performing a very large attack, the character issues a defend command to an allied party NPC. In another example, an NPC allied to the character is incapacitated, so the character issues an instruction to an enemy located within a predetermined range of the surroundings to come and apply a killing blow. Another example is when the character exposes a significant vulnerability, prompting a command for the enemy to target the opening.

In the modes above, modes are described in which the second information is provided with a valid period, as an example of the second information being valid until a predetermined condition is satisfied, but this example is not limiting. For example, the valid period may be endless. Further, as mentioned in reference to FIG. 7, the predetermined condition may be that the character is located in a certain area.

In the modes above, modes are described in which a character is an example of the first object of the present disclosure, but the first object of the present disclosure is not limited to characters and may be, for example, an other object. Moreover, in the described modes the other object is an example of the second object of the present disclosure, but the second object of the present disclosure is not limited to other objects and may be, for example, a character. Neither of the first object and the second object is limited to being an individual (an individual person or the like) but may be plural (plural people or the like).

The modes described above are modes in which each of the first to third information is one set of information, but each may be plural sets of information. For example, plural second information tags may be assigned to a character.

The processes that, in the exemplary embodiments described above, are executed by the CPU 11 reading software (a program) may be executed by various kinds of processor other than a CPU. Examples of processors in these cases include a PLD (programmable logic device) in which a circuit configuration can be modified after manufacturing, such as an FPGA (field-programmable gate array) or the like, a dedicated electronic circuit which is a processor with a circuit configuration that is specially designed to execute specific processing, such as an ASIC (application-specific integrated circuit) or the like, and so forth. Each process may be executed by one of these various kinds of processors, and may be executed by a combination of two or more processors of the same or different kinds (for example, plural FPGAs, a combination of a CPU with an FPGA, or the like). Hardware structures of these various kinds of processors are, to be more specific, electronic circuits combining circuit components such as semiconductor components and the like.

The program of the present disclosure may be supplied as a program product. The meaning of the term "program product" includes various kinds of products for supplying a program. For example, program products include the program itself being supplied via a network such as the Internet or the like, a recording medium storing the program such as a CD-ROM, a DVD or the like, and so forth.

In a computer game as described above, when a first object among plural objects is to perform an action relating to an event, the first object acquires information relating to the event and chooses an action of the first object on the basis of the acquired information.

However, if the first object does not continuously monitor an in-game environment outside the first object, then when the in-game environment changes or when there is a change in the event or the like, there may be problems in acquiring information required for executing the action relating to the event. Examples of these problems include time lags in acquiring information, situations in which the information cannot be acquired and the like. When this kind of problem occurs, there is concern that, for example, a timing of the action relating to the event may be out of sync or the action relating to the event may become impossible.

Therefore, in order to perform the action relating to the event, the first object must continuously monitor the in-game environment outside the first object. When the in-game environment is being continuously monitored, there may be problems with control of plural objects becoming complicated and the like.

An object of the present disclosure is to provide a non-transitory recording medium recording an information processing program, an information processing method and an information processing device that enable a first object to acquire information to be used for an action choice without continuously monitoring an in-game environment outside the first object.

A first aspect of the present disclosure is a non-transitory computer-readable recording medium storing instructions that are executable by a processor to perform operations, the operations including: causing a first object to acquire first information that the first object recognizes from among information about an environment in a computer game; causing a second object that is different from the first object to assign second information from among the information about the environment to the first object; causing the first object to choose an action of the first object on the basis of the first information and the second information; and causing the first object to execute the chosen action in the computer game.

A second aspect of the present disclosure is the non-transitory recording medium of the first aspect, wherein: the assignment of the second information is executed by assigning a corresponding information tag, the first object monitors for the corresponding information tag, in a case in which the information tag is valid, the second information corresponding to the information tag is used, and in a case in which the information tag is invalid, the information tag is erased.

A third aspect of the present disclosure is the non-transitory recording medium according to the first aspect, wherein: the second information assigned to the first object from the second object is valid until a predetermined condition is satisfied, and the action of the first object is chosen based on the first information and the second information in a case in which the second information is valid.

A fourth aspect of the present disclosure is the non-transitory recording medium of the third aspect, wherein the second information is assigned from the second object to a plurality of the first objects that are within a predetermined range.

A fifth aspect of the present disclosure is the non-transitory recording medium of the third aspect, wherein: the second information assigned from the second object to the first object relates to a predetermined action of the second object, and in a state in which the second information assigned to the first object is valid, the second object is caused to execute preparation for the predetermined action.

A sixth aspect of the present disclosure is the non-transitory recording medium of the first aspect, wherein: the second information assigned from the second object to the first object relates to a predetermined action of the second object, and the second object is caused to execute the predetermined action or preparation for the predetermined action.

A seventh aspect of the present disclosure is the non-transitory recording medium of the first aspect, wherein the operations further include: in a case in which the first object is caused to execute a corresponding action that is an action corresponding to the second information, causing the first object to assign, from among the information about the environment, third information, relating to the corresponding action of the first object, to the second object; and causing the second object to choose an action of the second object based on the third information.

A eighth aspect of the present disclosure is the non-transitory recording medium of the seventh aspect, wherein: the second information assigned from the second object to the first object is valid for a predetermined period; and the third information assigned from the first object to the second object is valid for a period that is shorter than the predetermined period.

A ninth aspect of the present disclosure is an information processing method executed by a processor to perform operations, the operations including: causing a first object to acquire first information that the first object recognizes from among information about an environment in a computer game; causing a second object that is different from the first object to assign second information from among the information about the environment to the first object; causing the first object to choose an action of the first object based on the first information and the second information; and causing the first object to execute the chosen action in the computer game.

A tenth aspect of the present disclosure is an information processing device including a processor, the processor being configured to: cause a first object to acquire first information that the first object recognizes from among information about an environment in a computer game; cause a second object that is different from the first object to assign second information from among the information about the environment to the first object; cause the first object to choose an action of the first object based on the first information and the second information; and cause the first object to execute the chosen action in the computer game.

According to the present disclosure, a first object may acquire information to be used in choosing an action without continuously monitoring an in-game environment apart from the first object itself.

What is claimed is:

1. A non-transitory computer-readable recording medium storing instructions that are executable by a processor to perform operations, the operations comprising:
causing a first object to acquire first information that the first object recognizes from among information about an environment in a computer game;
causing a second object that is different from the first object to assign second information from among the information about the environment to the first object;
causing the first object to choose an action of the first object on the basis of the first information and the second information; and
causing the first object to execute the chosen action in the computer game.

2. The non-transitory recording medium of claim 1, wherein:the assignment of the second information is executed by assigning a corresponding information tag,the first object monitors for the corresponding information tag,in a case in which the information tag is valid, the second information corresponding to the information tag is used, andin a case in which the information tag is invalid, the information tag is erased.

3. The non-transitory recording medium according to claim 1, wherein:the second information assigned to the first object from the second object is valid until a predetermined condition is satisfied, andthe action of the first object is chosen based on the first information and the second information in a case in which the second information is valid.

4. The non-transitory recording medium of claim 3, wherein the second information is assigned from the second object to a plurality of the first objects that are within a predetermined range.

5. The non-transitory recording medium of claim 3, wherein:the second information assigned from the second object to the first object relates to a predetermined action of the second object, andin a state in which the second information assigned to the first object is valid, the second object is caused to execute preparation for the predetermined action.

6. The non-transitory recording medium of claim 1, wherein:the second information assigned from the second object to the first object relates to a predetermined action of the second object, andthe second object is caused to execute the predetermined action or preparation for the predetermined action.

7. The non-transitory recording medium of claim 1, wherein the operations further comprise:in a case in which the first object is caused to execute a corresponding action that is an action corresponding to the second information, causing the first object to assign, from among the information about the environment, third information, relating to the corresponding action of the first object, to the second object; andcausing the second object to choose an action of the second object based on the third information.

8. The non-transitory recording medium of claim 7, wherein:the second information assigned from the second object to the first object is valid for a predetermined period; andthe third information assigned from the first object to the second object is valid for a period that is shorter than the predetermined period.

9. An information processing method executed by a processor to perform operations, the operations comprising:
causing a first object to acquire first information that the first object recognizes from among information about an environment in a computer game;
causing a second object that is different from the first object to assign second information from among the information about the environment to the first object;
causing the first object to choose an action of the first object based on the first information and the second information; and
causing the first object to execute the chosen action in the computer game.

10. An information processing device comprising a processor, the processor being configured to:cause a first object to acquire first information that the first object recognizes from among information about an environment in a computer game;
cause a second object that is different from the first object to assign second information from among the information about the environment to the first object;
cause the first object to choose an action of the first object based on the first information and the second information; and
cause the first object to execute the chosen action in the computer game.
